(19) United States
(12) Patent Application Publication
(10) Pub. No.: US 2024/0103917 A1
(43) Pub. Date: Mar. 28, 2024

(54) COMPUTER SYSTEM, PROCESSING METHOD, AND RECORDING MEDIUM

(71) Applicant: NEC Corporation, Tokyo (JP)

(72) Inventor: Takashi YOSHIKAWA, Tokyo (JP)

(73) Assignee: NEC Corporation, Tokyo (JP)

(21) Appl. No.: 18/533,583

(22) Filed: Dec. 8, 2023

(30) Foreign Application Priority Data
Feb. 15, 2022 (JP) 2022-200119

(51) Int. Cl. G06F 9/50

(52) U.S. Cl. CPC G06F 9/5005; G06F 9/5077

(57) ABSTRACT

A computer system including: a memory configured to store instructions; and a processor configured to execute instructions to realize one service by combining services which are provided using a plurality of pods coupled via a control network which is a network for performing control and a data network which is a network for performing transmission and reception of data, wherein realizing the one service comprises adding a pod to an arbitrary smart resource as one part of the plurality of pods.

This application is based upon and claims the benefit of priority from Japanese patent application No. 2022-200119, filed on Dec. 15, 2022, the disclosure of which is incorporated herein in its entirety by reference.

### TECHNICAL FIELD

The present disclosure relates to a computer system, a processing method, and a recording medium.

### BACKGROUND ART

A resource-disaggregated computer system can serve as various types of computers by recombining resources for reconfiguration. Accordingly, a resource-disaggregated computer system is excellent in realizing various types of functions and performance using a small amount of resources. Published Japanese Translation No. 2022-538897 of the PCT International Publication discloses a technique for adjusting a container-based application as a related technique thereof.

### SUMMARY

There are needs for a computer system of which performance can be appropriately scaled up or scaled out.

An example objective of aspects of the present disclosure is to provide a computer system, a processing method, and a recording medium that can solve the aforementioned problems.

In order to achieve the aforementioned objective, according to an example aspect of the present disclosure, there is provided a computer system including: a memory configured to store instructions; and a processor configured to execute instructions to realize one service by combining services which are provided using a plurality of pods coupled via a control network which is a network for performing control and a data network which is a network for performing transmission and reception of data, wherein realizing the one service comprises adding a pod to an arbitrary smart resource as one part of the plurality of pods.

In order to achieve the aforementioned objective, according to another example aspect of the present disclosure, there is provided a processing method that is performed by a computer system, the processing method including: executing instructions to realize one service by combining services which are provided using a plurality of pods coupled via a control network which is a network for performing control and a data network which is a network for performing transmission and reception of data, wherein realizing the one service comprises adding a pod to an arbitrary smart resource as one part of the plurality of pods.

In order to achieve the aforementioned objective, according to another example aspect of the present disclosure, there is provided a non-transitory computer-readable recording medium storing a program causing a computer system to execute instructions to realize one service by combining services which are provided using a plurality of pods coupled via a control network which is a network for performing control and a data network which is a network for performing transmission and reception of data, wherein realizing the one service comprises adding a pod to an arbitrary smart resource as one part of the plurality of pods.

According to the example aspects of the present disclosure, it is possible to appropriately scale up or scale out performance of a computer system.

### BRIEF DESCRIPTION OF THE DRAWINGS

FIG. 1 is a diagram illustrating an example of a configuration of a resource-disaggregated computer system according to example embodiments of the present disclosure.

FIG. 2 is a diagram illustrating an example of an architecture of the resource-disaggregated computer system according to the example embodiments of the present disclosure.

FIG. 3 is a diagram illustrating an example of a configuration of software which is loaded to one smart resource according to the example embodiments of the present disclosure.

FIG. 4 is a diagram illustrating an example of a process flow of all operations of the resource-disaggregated computer system according to the example embodiments of the present disclosure.

FIG. 5 is a diagram illustrating an example of a process flow when the resource-disaggregated computer system according to the example embodiments of the present disclosure executes an application program.

FIG. 6 is a diagram illustrating an example of a configuration of a resource-disaggregated computer system according to a comparative example.

FIG. 7 is a diagram illustrating an example of comparison between performance scales of the resource-disaggregated computer system according to the example embodiments of the present disclosure and performance scales of the resource-disaggregated computer system according to the comparative example.

FIG. 8 is a diagram illustrating a minimum configuration of the resource-disaggregated computer system according to the example embodiments of the present disclosure.

FIG. 9 is a diagram illustrating an example of a process flow of the computer system with the minimum configuration according to the example embodiments of the present disclosure.

FIG. 10 is a block diagram schematically illustrating a configuration of a computer according to at least one example embodiment.

### EXAMPLE EMBODIMENTS

Hereinafter, example embodiments will be described with reference to the drawings.

(Configuration of Resource-Disaggregated Computer System)

A resource-disaggregated computer system 101 according to example embodiments of the present disclosure will be described below with reference to the drawings. The resource-disaggregated computer system 101 is a system that can serve as various types of computers by recombining resources for reconfiguration.

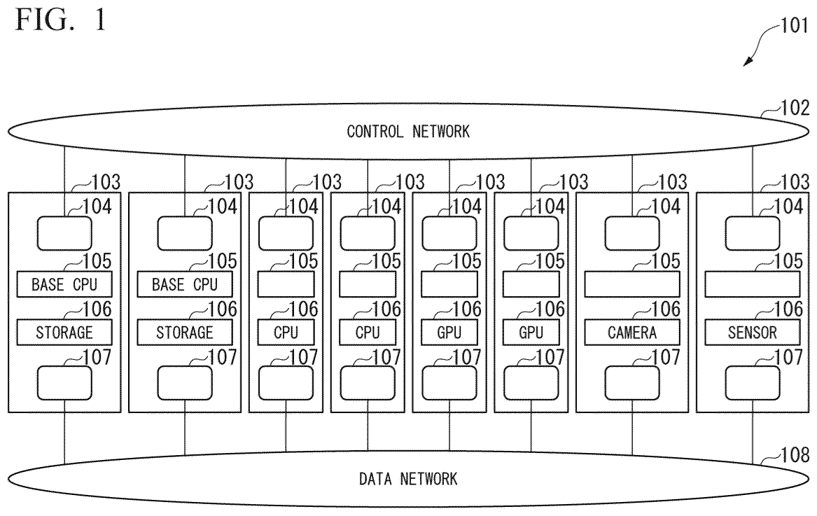

FIG. 1 is a diagram illustrating an example of a configuration of the resource-disaggregated computer system 101 according to the example embodiments of the present disclosure. As illustrated in FIG. 1, the resource-disaggregated computer system 101 includes a control network 102, a smart resource 103, and a data network 108.

The data network 108 is a network for transmitting data which is processed by the resource-disaggregated computer system 101. The control network 102 is a network for transmitting signals or data used for control or management associated with the operation of the resource-disaggregated computer system 101.

The smart resource 103 is an input/output (T/O) device that includes a central processing unit (CPU) and can operate software using a device function on an operating system (OS). As illustrated in FIG. 1, a plurality of smart resources 103 are present between the control network 102 and the data network 108. The smart resources 103 couple the control network 102 and the data network 108.

As illustrated in FIG. 1, each smart resource 103 includes a service providing function 104, a base CPU 105, a functional device 106, and a data sharing function 107. The service providing function 104 and the data sharing function 107 are functions which are realized by software. In the base CPU, the OS operates. An example of the OS is LINUX. The base CPU 105 realizes the functions such as the service providing function 104 and the data sharing function 107 by executing software. Examples of the functional device 106 include a storage, a graphics processing unit (GPU) accelerator, an I/O device such as a camera or a sensor, a memory, and a CPU.

The resource-disaggregated computer system 101 includes smart resources 103 including the base CPU 105 in addition to the functional device 106 as hardware elements. An OS is mounted on the base CPU 105, and the smart resources 103 is not just a device but can operate alone.

Each smart resource 103 is connected to other smart resources 103 via the control network 102 and the data network 108. Here, the control network 102 and the data network 108 may be shared as one network. In any case, the networks are characterized by coarse coupling based on data packet communication, not dense coupling based on direct memory access (DMA) which is direct memory transmission. Specifically, when transmission between memories is performed, matching of a memory address between one smart resource 103 and another smart resource 103 is performed using remote DMA (RDMA). Here, transmission of data is performed using packet communication.

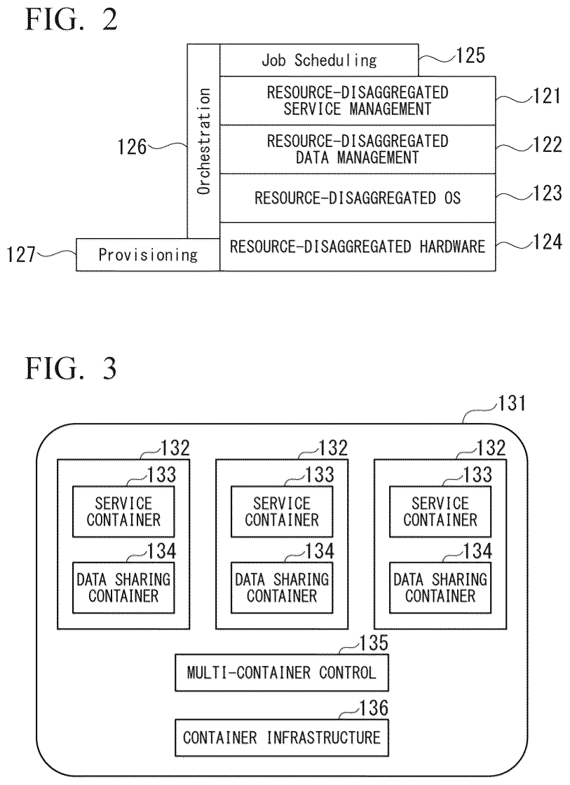

FIG. 2 is a diagram illustrating an example of an architecture of the resource-disaggregated computer system 101 according to the example embodiments of the present disclosure. As illustrated in FIG. 2, the architecture of the resource-disaggregated computer system 101 includes a resource-disaggregated service management layer 121, a resource-disaggregated data management layer 122, a resource-disaggregated OS layer 123, a resource-disaggregated infrastructure hardware layer 124, a resource-disaggregated job scheduler 125, a resource-disaggregated orchestrator 126, and a resource-disaggregated provisioner 127.

The resource-disaggregated infrastructure hardware layer 124 is hardware with a resource-disaggregated basic configuration for mounting various resources thereon. In the resource-disaggregated infrastructure hardware layer 124, smart resources 103 each including a CPU are coupled via an interconnection network such as Ethernet or Infiniband.

The resource-disaggregated OS layer 123 performs a function corresponding to an OS such as memory management, scheduling, and I/O processing on disaggregated resources at the time of realization of a resource-disaggregated memory pool.

The resource-disaggregated data management layer 122 realizes sharing of data between respective smart resources of the resource-disaggregated infrastructure hardware layer 124.

The resource-disaggregated service management layer 121 provides one data processing function using devices of each of the smart resources. The resource-disaggregated service management layer 121 couples processes in a plurality of similar containers and executes one application program.

The resource-disaggregated orchestrator 126 prepares a computer environment by causing the resource-disaggregated provisioner 127 to select appropriate resources for a plurality of jobs from a plurality of users requested to the resource-disaggregated job scheduler 125. The resource-disaggregated orchestrator 126 controls the resource-disaggregated job scheduler 125 and the resource-disaggregated provisioner 127 such that the resource-disaggregated job scheduler 125 can perform jobs.

The computer system that is realized by the architecture of the resource-disaggregated computer system 101 is a computer system that performs a plurality of services of a plurality of users through optimization in view of the amount of resources and execution performance.

FIG. 3 is a diagram illustrating an example of a configuration of a software part 131 that is loaded into one smart resource 103 according to the example embodiments of the present disclosure. FIG. 3 illustrates a functional block diagram of the software part 131 when the software part is installed using containers. The software part 131 operates on the base CPU 105. As illustrated in FIG. 3, the software part 131 includes a plurality of service pods 132, a multi-container control 135 (an example of a first processing unit, an example of a second processing unit), and a container infrastructure 136. Each service pod 132 includes a service container 133 and a data sharing container 134 as illustrated in FIG. 3. The service container 133 is obtained by making the service providing function 104 illustrated in FIG. 1 into a container. The data sharing container 134 is obtained by making the data sharing function 107 illustrated in FIG. 1 into a container.

The service container 133 provides a service using the function of the corresponding smart resource 103. The data sharing container 134 enables the service container 133 to share data of a target service along with another service pod 132.

The container infrastructure 136 can construct a plurality of computer environments which are virtualized on the smart resource 103. Docker, singularity, or the like is used as the container infrastructure 136.

The multi-container control 135 can perform control for setting up or deleting a plurality of containers by operating the container infrastructure over a plurality of computers under the control via the control network 102. For example, the multi-container control 135 adds a service pod 132 (an example of a pod) to an arbitrary smart resource 103 as one of a plurality of service pods 132 (an example of a pod). For example, when the added service pod becomes unnecessary, the multi-container control 135 removes the unnecessary service pod from the plurality of service pods 132. Kubernetes or the like is used as the multi-container control 135.

The multi-container control 135 can freely dispose the service pods 132 on the same smart resource 103 or different smart resources 103 connected to a network as a unit of which a service pod 132 for performing one function or service by combining a plurality of containers.

Each service pod 132 performs data processing using the functions of devices mounted on the smart resources 103.

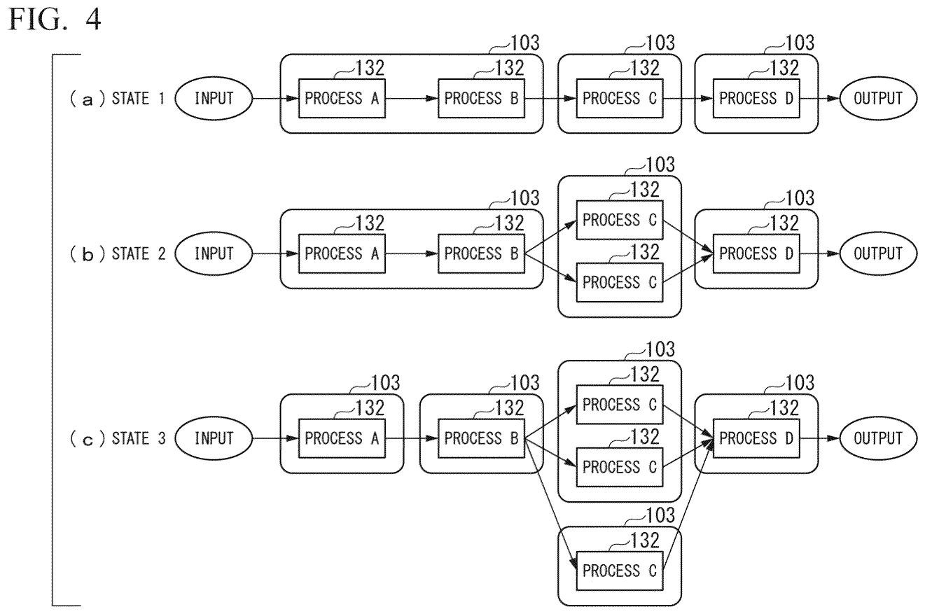

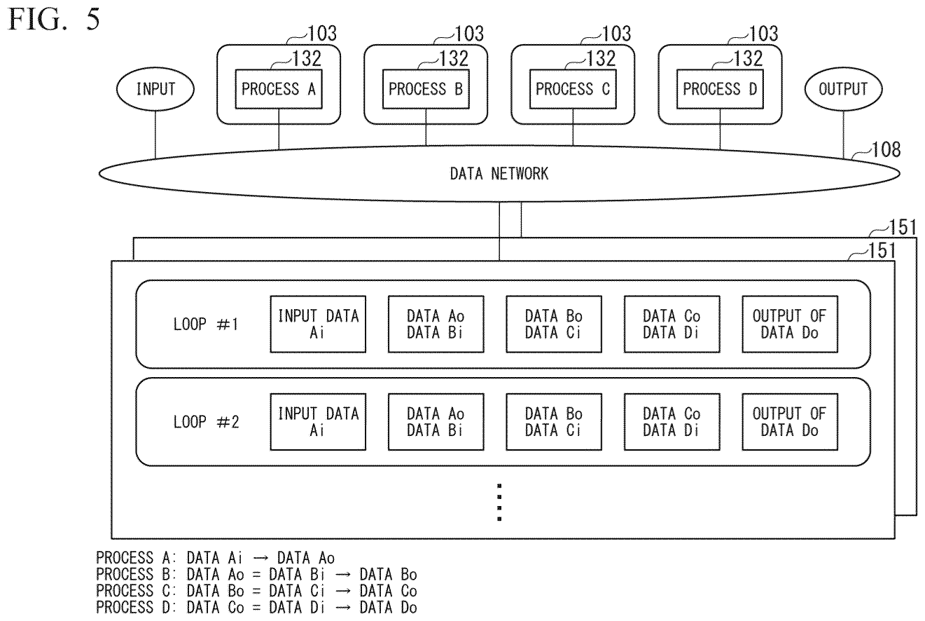

Processes which are performed by the resource-disaggregated computer system 101 will be described below. FIG. 4 is a diagram illustrating an example of a process flow of whole operations which are performed by the resource-disaggregated computer system 101 according to the example embodiments of the present disclosure. FIG. 5 is a diagram illustrating an example of a process flow when the resource-disaggregated computer system 101 according to the example embodiments of the present disclosure executes an application program. The processes which are performed by the resource-disaggregated computer system 101 will be described below with reference to FIGS. 4 and 5.

First, the whole operations of the resource-disaggregated computer system 101 will be described with reference to FIG. 4.

In the resource-disaggregated computer system 101, the resource-disaggregated service management layer 121 separates a process performed by one application program according to process characteristics, that is, by what devices the process can be appropriately performed. The resource-disaggregated computer system 101 performs each of the separated processes in a service pod 132 on a smart resource 103 that is appropriate for each processing.

The application program is separated into four processes such as processes A to D. The resource-disaggregated computer system 101 sets up a service pod 132 on a smart resource 103 and performs the four processes.

Part (a) of FIG. 4 illustrates the processes of the resource-disaggregated computer system 101 in State 1. Part (b) of FIG. 4 illustrates the processes of the resource-disaggregated computer system 101 in State 2. Part (c) of FIG. 4 illustrates the processes of the resource-disaggregated computer system 101 in State 3.

In State 1, a load is not large and thus the resource-disaggregated computer system 101 performs the four processes using the same device. Even when the service pod 132 for performing processes A and B are set up on the same smart resource 103 and the processes are performed by the resource-disaggregated computer system 101, processing capability is sufficient. Thereafter, when an input is changed to increase only the load of process C, the resource-disaggregated computer system 101 switches to State 2 in which only the number of service pods 132 performing process C is increased to two and distributed processing is performed. Accordingly, the resource-disaggregated computer system 101 can maintain a throughput of the whole processes.

In State 3 in which the load is further increased, processes A and B cannot be placed on the same smart resource 103. In this case, the resource-disaggregated computer system 101 sets up a service pod 132 performing process B newly using the smart resource 103 having been performing process A. At the same time, a service pod 132 performing process C is added to increase the number of service pods to three. As a result, the resource-disaggregated computer system 101 can set up a third service pod 132 and perform distributed-process for process C using three service pods 132 without affecting the operations of two service pods 132 which are performing process C by adding the same type of smart resource 103 to the system and setting up the third service pod 132 therein. That is, the resource-disaggregated computer system 101 is reconfigured such that distributed processing can be performed by adding one smart resource 103 appropriate for process A and process B and one smart resource 103 appropriate for process C and increasing the number of service pods 132 for performing process C from one to three for the purpose of performance required for from state 1 to state 3. This reconfiguration can be dynamically performed by software for multi-container control. Accordingly, the resource-disaggregated computer system 101 can keep a use rate of resources high according to a load without stopping a service.

A process when the resource-disaggregated computer system 101 performs an application program will be described below with referenced to FIG. 5.

For a data processing application program that performs four processes such as processes A to D in response to an input and outputs a result, the resource-disaggregated computer system 101 performs processes A to D on different service pods 132. The service pods 132 are connected to a sharing storage 151 via the data network 108. The resource-disaggregated computer system 101 reads each input data from a storage area in the sharing storage 151 in each process. The resource-disaggregated computer system 101 writes a processing result in the storage area in the sharing storage 151 in each process. The resource-disaggregated computer system 101 receives an output of process A as an input of process B, performs process B, performs process C using the result of process B as an input of process C, and performs process D using the result of process C as an input of process D. The resource-disaggregated computer system 101 generates output data by performing four processes using the input through this flow from process A to process D. Each service pod 132 repeats a sequence of performing processes and writing a result when there is data with anew loop number. Since a series of processes are taken over with a loop number as a key, each service pod 132 performs a process sequence based on a series of application programs without performing any particular control. In some application programs, the resource-disaggregated computer system 101 may perform control of data and processes via the control network 102 instead of taking over the process sequence through the aforementioned flow of data.

### Advantageous Effects

The resource-disaggregated computer system 101 according to example embodiments of the present disclosure has been described above. The resource-disaggregated computer system 101 (an example of a computer system) is a computer system that executes an application program for realizing one service by combining services which are provided using a plurality of service pods 132 (an example of pods) coupled via a control network 102 which is a network for performing control and a data network 108 which is a network for performing transmission and reception of data, wherein a service pod 132 is added to an arbitrary smart resource 103 as one part of the plurality of service pods 132. Accordingly, it is possible to appropriately scale up or scale out performance of the computer system.

With the resource-disaggregated computer system 101 according to example embodiments of the present disclosure, it is possible to construct a computer system by combining various types of resources in the units of smart resources 103, not in the units of servers. Accordingly, the resource-disaggregated computer system 101 can realize various types of services with a small absolute amount of resources.

With the resource-disaggregated computer system 101, it is possible to execute an application program by additionally combining a service pod 132 utilizing functions of resources. Accordingly, it is possible to dynamically scale performance of the resource-disaggregated computer system 101 while performing a service. As a result, with the resource-disaggregated computer system 101, it is possible to reduce a difference between resources secured for necessary performance and actually used resources. That is, it is possible to enhance the use rate of resources.

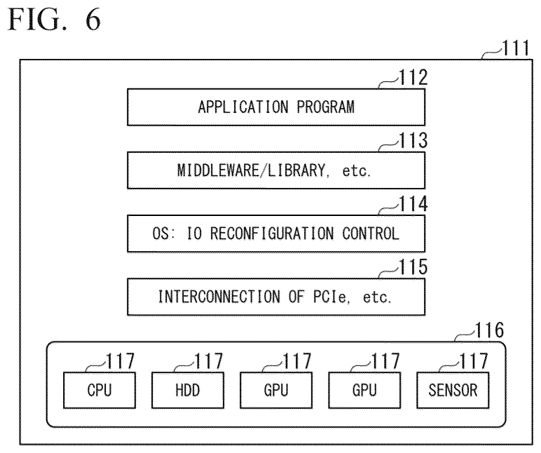

A resource-disaggregated computer system 111 which is a comparative example will be described below. FIG. 6 is a diagram illustrating an example of a configuration of the resource-disaggregated computer system 111 according to a comparative example. As illustrated in FIG. 6, the resource-disaggregated computer system 111 includes an application program 112, a middleware/library 113, an OS 114, an I/O system bus 115 (illustrated as an interconnection such as PCIe in FIG. 6), and a device pool 116. The device pool 116 includes I/O devices 117. The resource-disaggregated computer system 111 changes its configuration by connecting or disconnecting a CPU and an I/O device using a coupling network such as PCI Express.

The resource-disaggregated computer system 111 often includes a plurality of expansion slots of PCI Express which are called PCI expanders as an I/O device pool. Each of the plurality of expansion slots of PCI Express is connected with PCI Express switch in the resource-disaggregated computer system 111. When a system bus into which the PCI Express is virtualized is used, other switches such as Ethernet may be used.

A system manager can reconfigure the resource-disaggregated computer system 111 by controlling contact of such switches to determine what I/O device is to be connected to the CPU. At that time, a hot-plug operation needs to be performed normally in cooperation with the OS in order to change the configuration in a powered-on state. The hot-plug operation is attaching or detaching an I/O device in a state in which the computer system is turned on.

However, there are many I/O devices that do not support the hot-plug operation. An example thereof is a GPU which is an I/O device of which the number of users is large. A main reason why the GPU does not support the hot-plug operation is that a memory space required by the GPU is much larger than that of other devices and is not fit into a base address register (BAR) space prepared for a hot plug by the OS in advance.

On the other hand, device hardware and a device driver need to support the hot plug operation and to operate in cooperation with the OS and the PCI Express in order for the device to support the hot plug. Accordingly, even when there are devices supporting the hot plug, the devices supporting the hot plug may not operate normally when there are many devices not supporting the hot plug.

When it is intended to use an I/O device not supporting the hot plug, the resource-disaggregated computer system 111 needs to be shut down and then restarted after the I/O device attached thereto.

On the other hand, when a device is removed, almost all the devices do not support sudden removal (that is, sudden removal of a device is not permitted). The reason why almost all the devices do not support sudden removal is that data is deleted or the CPU stalls while waiting for a response from a device on the way of an access when the device does not also support the PCI Express and the device is not removed after an access to the device on the OS has ended.

That is, the resource-disaggregated computer system 111 can be reconfigured by attaching or detaching an I/O device at the level of PCI. However, in general, a computer system takes time to perform processes of managing devices on the OS or applying a driver (for example, time less than 1 minute is required for an OS such as LINUX) when an I/O device is attached or detached. When the I/O device does not support the hot plug, it takes several minutes to restart. These operations affect all users in the resource-disaggregated computer system 111. Accordingly, the resource-disaggregated computer system 111 is not suitable for multi-tenants shared by a plurality of users.

In general, virtualization of securely distributing and sharing computers such that the computers cannot recognize each other may be used as a technique of realizing multi-tenants in a computer system. In this case, for example, virtual machines for allowing a hypervisor to divide an execution time of a CPU as if separate CPUs were present and to virtually realize a plurality of computers or containers for allowing an execution environment to be divided to a plurality of users on an OS as if a plurality of computers were present are used.

In general, in virtual machines based on a hypervisor, each user includes an OS layer and layers thereon. Accordingly, each user needs computer resources. As a result, the number of users sharing one computer is limited in performance. In many cases, one user is allocated to each core of a CPU to reduce the number of context switches, and thus virtual machines can operate such that the number of cores is equal to the maximum number of users. It takes several tens of seconds to several minutes, which is equivalent to starting of an OS, to start a virtual machine.

In general, when containers are used, a host has an OS layer. The OS layer includes only an environment in which an application program is executed as a container image. Accordingly, the amount of resources held by the OS layer is small, and thus many containers can be operated with one computer. It takes several seconds to start a container. A platform is shared by the containers. Accordingly, in general, a computer system using containers is suitable for a use case in which a homogeneous computer environment such as an environment in which one user performs a large-scale web service is copied a plurality of times for use. On the other hand, in general, when performance or functions differing between users are required, particularly, when I/O devices to be used are different, a computer system using containers is not suitable for such a use case in which a homogeneous computer environment is copied a plurality of times for use.

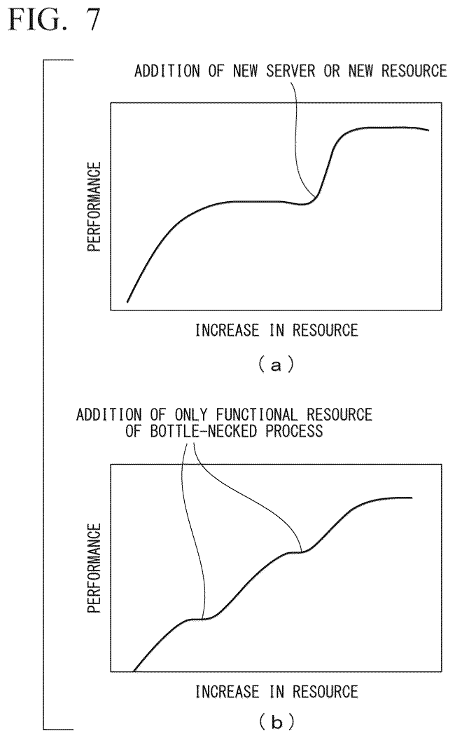

FIG. 7 is a diagram illustrating an example of comparison between a performance scale of the resource-disaggregated computer system 101 according to the example embodiments of the present disclosure and a performance scale of the resource-disaggregated computer system 111 according to the comparative example. Part (a) of FIG. 7 illustrates the concept of performance scales of the resource-disaggregated computer system 111. Part (b) of FIG. 7 illustrates the concept of performance scales of the resource-disaggregated computer system 101. In the resource-disaggregated computer system 111 according to the comparative example, when the number of virtual machines or the number of containers is increased to scale out, the performance thereof is limited with one resource. Therefore, it is conceivable that anew server or anew resource be added to the resource-disaggregated computer system 111. In this case, the performance scales of the resource-disaggregated computer system 111 are the same as the performance scales illustrated in part (a) of FIG. 7, but the performance increases suddenly more than necessary and thus the use rate of resources decreases. On the other hand, in the resource-disaggregated computer system 101, the number of service pods for only a bottle-necked process has only to be increased. Accordingly, as illustrated in part (b) of FIG. 7, the performance scales of the resource-disaggregated computer system 101 are smaller in sudden change than the performance scales of the resource-disaggregated computer system 111. In addition, in the resource-disaggregated computer system 101, a device does not need to be attached or detached at the PCI level even when a new resource is added. Accordingly, it is possible to scale up and scale out the performance of the resource-disaggregated computer system 101 without affecting a service in operation.

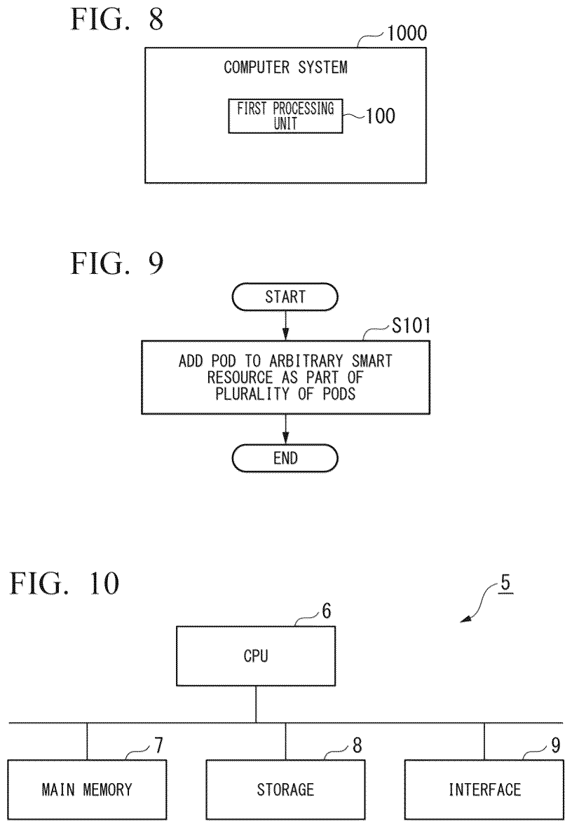

FIG. 8 is a diagram illustrating a minimum configuration of a computer system 1000 according to example embodiments of the present disclosure. The computer system 1000 illustrated in FIG. 8 is a computer system that executes an application program for realizing one service by combining services which are provided using a plurality of pods coupled via a control network which is a network for performing control and a data network which is a network for performing transmission and reception of data, the computer system including a first processing unit 100 configured to add a pod to an arbitrary smart resource as one part of the plurality of pods. The first processing unit 100 can be realized, for example, using the function of the multi-container control 135 illustrated in FIG. 3.

FIG. 9 is a diagram illustrating an example of a process flow which is performed by the computer system 1000 with the minimum configuration according to the example embodiments of the present disclosure. The process flow of the computer system 1000 with the minimum configuration according to the example embodiments of the present disclosure will be described below with reference to FIG. 9.

The first processing unit 100 is a computer system that executes an application program for realizing one service by combining services which are provided using a plurality of pods coupled via a control network which is a network for performing control and a data network which is a network for performing transmission and reception of data. The computer system 1000 adds a pod to an arbitrary smart resource as one part of the plurality of pods (Step S101).

The computer system 1000 with the minimum configuration according to the example embodiments of the present disclosure has been described above. With this computer system 1000, it is possible to appropriately scale up or scale out the performance of the computer system.

The order of the process according to the example embodiments of the present disclosure may be changed as long as appropriate processes can be performed.

While example embodiments of the present disclosure has been described above, the resource-disaggregated computer system 101 and other control devices may include a computer system therein. The aforementioned process is stored in the form of programs in a computer-readable recording medium and is performed by causing a computer to read and execute the programs. A specific example of the computer will be described below.

FIG. 10 is a block diagram schematically illustrating a configuration of a computer according to at least one example embodiment. The computer 5 includes a CPU 6, a main memory 7, a storage 8, and an interface 9 as illustrated in FIG. 10.

For example, the resource-disaggregated computer system 101 and the other control devices are mounted in the computer 5. The operations of the aforementioned processing units are stored in the form of programs in the storage 8. The CPU 6 reads the programs from the storage 8, loads the read programs into the main memory 7, and performs the process in accordance with the programs. The CPU 6 secures storage areas corresponding to the aforementioned storage units in the main memory 7 according to the programs.

Examples of the storage 8 include a hard disk drive (HDD), a solid state drive (SSD), a magnetic disk, a magneto-optical disc, a compact disc read only memory (CD-ROM), a digital versatile disc read only memory (DVD-ROM), and a semiconductor memory. The storage 8 may be internal media directly connected to a bus of the computer 5 or may be external media connected to the computer 5 via the interface 9 or a communication line. When the programs are transmitted to the computer 5 via a communication line, the computer 5 having received the programs may load the programs into the main memory 7 and perform the process. In at least one example embodiment, the storage 8 is a non-transitory materialized storage medium.

The programs may realize some of the aforementioned functions. The programs may be a file, so-called differential file (differential programs), that can realize the aforementioned functions in combination with programs stored in advance in the computer system.

While some example embodiments of the present disclosure have been described above, these example embodiments are merely examples and do not limit the scope of the present disclosure. These example embodiments may be subjected to various additions, omissions, replacements, and modifications without departing from the gist of the present disclosure.

Some or all of the example embodiments may be described as the following Supplementary Notes, but the present disclosure is not limited thereto.

(Supplementary Note 1)

A computer system including:
a memory configured to store instructions; and
a processor configured to execute instructions to realize one service by combining services which are provided using a plurality of pods coupled via a control network which is a network for performing control and a data network which is a network for performing transmission and reception of data,
wherein realizing the one service comprises adding a pod to an arbitrary smart resource as one part of the plurality of pods.

(Supplementary Note 2)

The computer system according to Supplementary Note 1, wherein the processor is configured to execute the instructions to:
perform addition of a pod to the arbitrary smart resource under the control via the control network.

(Supplementary Note 3)

The computer system according to Supplementary Note 1 or 2, wherein the processor is configured to execute the instructions to:
remove the unnecessary pod from the plurality of pods when the added pod becomes unnecessary.

(Supplementary Note 4)

The computer system according to Supplementary Note 3, wherein the processor is configured to execute of the instructions to:
perform exclusion of the unnecessary pod under the control via the control network.

(Supplementary Note 5)

The computer system according to any one of Supplementary Notes 1 to 4, wherein the arbitrary smart resource includes at least one of a storage, a graphics processing unit (GPU) accelerator, an input/output (I/O) device which is a camera or a sensor, a memory, and a central processing unit (CPU).

(Supplementary Note 6)

A processing method that is performed by a computer system, the processing method including:
executing instructions to realize one service by combining services which are provided using a plurality of pods coupled via a control network which is a network for performing control and a data network which is a network for performing transmission and reception of data,
wherein realizing the one service comprises adding a pod to an arbitrary smart resource as one part of the plurality of pods.

(Supplementary Note 7)

A non-transitory computer-readable recording medium storing a program causing a computer system to execute instructions to realize one service by combining services which are provided using a plurality of pods coupled via a control network which is a network for performing control and a data network which is a network for performing transmission and reception of data,
wherein realizing the one service comprises adding a pod to an arbitrary smart resource as one part of the plurality of pods.

What is claimed is:

1. A computer system comprising:
a memory configured to store instructions; and
a processor configured to execute instructions to realize one service by combining services which are provided using a plurality of pods coupled via a control network which is a network for performing control and a data network which is a network for performing transmission and reception of data,
wherein realizing the one service comprises adding a pod to an arbitrary smart resource as one part of the plurality of pods.

2. The computer system according to claim 1, wherein the processor is configured to execute the instructions to:
perform addition of a pod to the arbitrary smart resource under the control via the control network.

3. The computer system according to claim 1, wherein the processor is configured to execute the instructions to:
remove the unnecessary pod from the plurality of pods when the added pod becomes unnecessary.

4. The computer system according to claim 3, wherein the processor is configured to execute the instructions to:
perform exclusion of the unnecessary pod under the control via the control network.

5. The computer system according to claim 1, wherein the arbitrary smart resource includes at least one of a storage, a graphics processing unit (GPU) accelerator, an input/output (I/O) device which is a camera or a sensor, a memory, and a central processing unit (CPU).

6. A processing method that is performed by a computer system, the processing method comprising:
executing instructions to realize one service by combining services which are provided using a plurality of pods coupled via a control network which is a network for performing control and a data network which is a network for performing transmission and reception of data,
wherein realizing the one service comprises adding a pod to an arbitrary smart resource as one part of the plurality of pods.

7. A non-transitory computer-readable recording medium storing a program causing a computer system to execute instructions to realize one service by combining services which are provided using a plurality of pods coupled via a control network which is a network for performing control and a data network which is a network for performing transmission and reception of data,
wherein realizing the one service comprises adding a pod to an arbitrary smart resource as one part of the plurality of pods.
